(19) United States
(12) Patent Application Publication
(10) Pub. No.: US 2023/0385306 A1
(43) Pub. Date: Nov. 30, 2023

(54) INFORMATION PROCESSING APPARATUS, INFORMATION PROCESSING METHOD, AND RECORDING MEDIUM

(71) Applicant: CANON KABUSHIKI KAISHA, Tokyo (JP)

(72) Inventors: SHOJI TANAKA, Kanagawa (JP); KOJI MAKITA, Kanagawa (JP)

(21) Appl. No.: 18/323,301

(22) Filed: May 24, 2023

(30) Foreign Application Priority Data
May 30, 2022 (JP) 2022-087373

(51) Int. Cl. G06F 16/28

(52) U.S. Cl. CPC G06F 16/285

(57) ABSTRACT

An apparatus includes a clustering unit configured to perform clustering on a data group based on a feature value of each of a plurality of pieces of data, a determination unit determines a representative cluster among clusters generated by the clustering unit, a first identification identifies a first cluster based on a degree of similarity between each of the clusters generated by the clustering unit and the representative cluster, a second identification unit identifies a second cluster based on a first degree of similarity, which is the degree of similarity between each of the clusters generated by the clustering unit and the representative cluster, and a second degree of similarity, which is a degree of similarity between each of the clusters generated by the clustering unit and the first cluster, and a selection unit selects data for display from among the representative cluster, the first cluster, and the second cluster.

### BACKGROUND OF THE DISCLOSURE

### Field of the Disclosure

The present disclosure relates to data analysis techniques.

### Description of the Related Art

Face authentication techniques using deep learning utilize an authentication system trained with different face images of an identical human figure as training data. There is known a method of automatically performing annotation on a group of face images of an identical human figure that is identified by a method such as clustering, based on feature values extracted from the face images, among methods for creating such training data. In the automatic annotation by clustering, in some cases, face images of a human figure are classified into different clusters, and face images of different human figures are classified into an identical cluster. International Publication No. 2010/041377 discusses a method of selecting a cluster including display target images based on likelihood as a result of clustering, and displaying the selected cluster and the images belonging to the cluster, for an operator to correct the result of clustering.

However, the method discussed in International Publication No. 2010/041377, a cluster with the highest likelihood in clustering is first selected as a display target, and subsequently, clusters are sequentially selected in ascending order of likelihood from a cluster with the lowest likelihood as display targets. Because of a low degree of similarity between a cluster with high likelihood in clustering and a cluster with low likelihood in clustering, face images belonging to the clusters at mutually low degrees of similarity are displayed together on a screen. This results in an issue that the displayed face images are likely to be determined to be different human figures that are actually a human figure, which likely to cause an error in checking and correcting a result of clustering.

### SUMMARY OF THE DISCLOSURE

According to an aspect of the present disclosure, an information processing apparatus includes a clustering unit configured to perform clustering on a data group based on a feature value of each of a plurality of pieces of data, a determination unit configured to determine a representative cluster among clusters generated by the clustering unit, a first identification unit configured to identify a first cluster based on a degree of similarity between each of the clusters generated by the clustering unit and the representative cluster, a second identification unit configured to identify a second cluster based on a first degree of similarity, which is the degree of similarity between each of the clusters generated by the clustering unit and the representative cluster, and a second degree of similarity, which is a degree of similarity between each of the clusters generated by the clustering unit and the first cluster, and a selection unit configured to select at least one piece of data for display from among the representative cluster, the first cluster, and the second cluster.

Further features of the present disclosure will become apparent from the following description of exemplary embodiments with reference to the attached drawings.

### BRIEF DESCRIPTION OF THE DRAWINGS

FIG. 1 illustrates a hardware configuration example of an information processing apparatus according to a first exemplary embodiment.

FIG. 2 illustrates a functional configuration example of the information processing apparatus according to the first exemplary embodiment.

FIG. 3 is a flowchart illustrating display control processing according to the first exemplary embodiment.

FIG. 4 illustrates a result of clustering.

FIG. 5 illustrates degrees of similarity between clusters.

FIG. 6 illustrates an example of a display screen.

FIG. 7 illustrates an example of a display screen.

### DESCRIPTION OF THE EMBODIMENTS

Exemplary embodiments of the present disclosure will be described below with reference to the accompanying drawings.

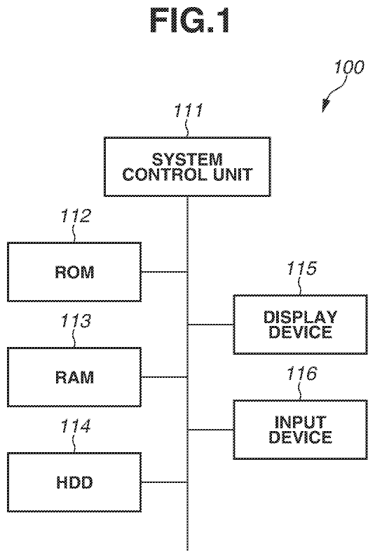

A first exemplary embodiment will now be described. FIG. 1 illustrates a hardware configuration example of an information processing apparatus according to the present exemplary embodiment. An information processing apparatus 100 includes a system control unit 111, a read-only memory (ROM) 112, a random-access memory (RAM) 113, a hard disk drive (HDD) 114, a display device 115, and an input device 116. These units are connected to one another through a bus. The system control unit 111 performs integrated control of the whole of the information processing apparatus 100.

The system control unit 111 includes a central processing unit (CPU), and a graphics processing unit (GPU), and reads out programs stored in the ROM 112 or the HDD 114 to perform various types of processing. The RAM 113 is used as a temporary storage area, such as a main memory and work area of the system control unit 111. The ROM 112 stores various kinds of data and various kinds of programs. The HDD 114 is a secondary storage area that stores data used in performing clustering and various kinds of programs. Functions and processing of the information processing apparatus 100, which will be described below, are implemented by the system control unit 111 running programs stored in the ROM 112 or the HDD 114.

The display device 115 includes a display, and displays various kinds of information. The input device 116 includes a keyboard and a mouse, and accepts various kinds of operations performed by a user. The display device 115 and the input device 116 may be integrated like a touch panel display. The display device 115 may be a device that performs projection with a projector. The input device 116 may be a device that recognizes the position of a fingertip in a projected image with a camera.

The configuration of the information processing apparatus 100 is not limited to a configuration in which the HDD 114, the display device 115, and the input device 116 are arranged inside the housing of the information processing apparatus 100 as illustrated in FIG. 1. The display device 115 and the input device 116 may be each included as an external device that is connected through a communication interface (I/F) (not illustrated). The external device may a mobile terminal, such as a user's smartphone. The information processing apparatus 100 itself may be a mobile terminal. For example, the display device 115 and the input device 116 may include the touch panel display of a smartphone. Similarly, the HDD 114 may be included as an external storage device that is connected through the communication I/F.

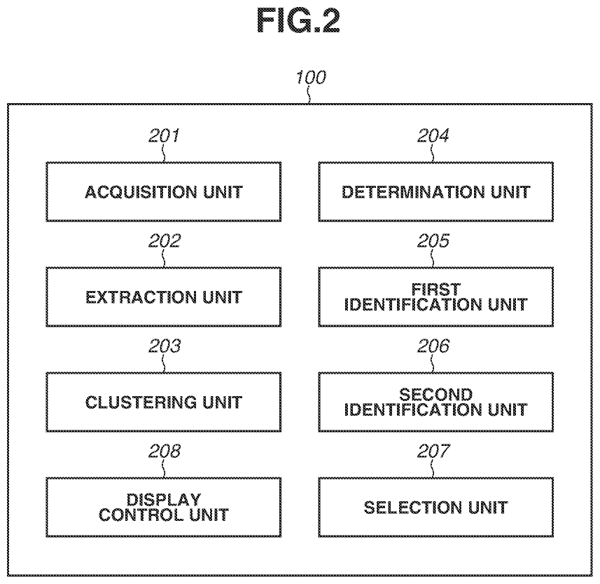

FIG. 2 illustrates a functional configuration example of the information processing apparatus 100 according to the first exemplary embodiment. The information processing apparatus 100 includes an acquisition unit 201, an extraction unit 202, a clustering unit 203, a determination unit 204, a first identification unit 205, a second identification unit 206, a selection unit 207, and a display control unit 208, as functional units.

The acquisition unit 201 acquires a data group as a processing target. In the present exemplary embodiment, data as the processing target is face images. As a face image group serving as the processing target, the acquisition unit 201 collects a face image group estimated to belong to an identical human figure by using, for example, a system that searches images recorded by a monitoring camera for a specific human figure or web search with a name of the specific human figure as a search query. Processing target data is not limited to face images. Examples of a data group estimated to be of an identical type include print data collected for specific characters or handwriting image data, and image data collected for specific objects (an automobile of a specific type). Assume that a face image group that is estimated to be of an identical human figure and that is acquired by the acquisition unit 201 is an image group collected on the premise that face images of a human figure “A” are to be collected.

The extraction unit 202 extracts feature values from the data group, as the processing target, that is acquired by the acquisition unit 201. Details of a feature value extraction method will be described below.

The clustering unit 203 performs clustering of a plurality of pieces of data (the face image group here) based on the feature values extracted by the extraction unit 202. Details of the clustering will be described below.

The determination unit 204 determines a core cluster, i.e., a cluster composed of a representative image group of image groups acquired by the acquisition unit 201, among clusters generated by clustering performed by the clustering unit 203. The core cluster herein is a cluster composed of a face image group with the highest likelihood of being “A”. The core cluster is an example of a representative cluster. Details of a method of determining the core cluster will be described below.

The first identification unit 205 identifies a first cluster based on degrees of similarity between each cluster generated by clustering performed by the clustering unit 203 and the core cluster determined by the determination unit 204. In the present exemplary embodiment, the first identification unit 205 identifies a cluster composed of an image group with the lowest degree of similarity to an image group constituting the core cluster as the first cluster, among the clusters generated by clustering performed by the clustering unit 203. In other words, the first identification unit 205 identifies the cluster composed of the face image group with the lowest likelihood of being “A”. Details of a method of identifying the first cluster will be described below.

The second identification unit 206 identifies a second cluster based on degrees of similarity to the core cluster (a first degree of similarity) and degrees of similarity to the first cluster (a second degree of similarity), among the clusters generated by clustering performed by the clustering unit 203. In the present exemplary embodiment, the second identification unit 206 identifies a cluster with a degree of similarity to an image group constituting the core cluster within a middle range and with a degree of similarity to an image group constituting the first cluster within a middle range as the second cluster, among the clusters generated by the clustering unit 203. In other words, the second identification unit 206 identifies the cluster composed of the face image group with an intermediate value of likelihood of being “A” among the face image group acquired by the acquisition unit 201. Details of a method of identifying the second cluster will be described below.

The selection unit 207 selects face images as display targets from among the core cluster determined by the determination unit 204, the first cluster identified by the first identification unit 205, and the second cluster identified by the second identification unit 206. Details of a selection method will be described below. Each face image selected herein is an example of data for display.

The display control unit 208 performs control to display the face images selected by the selection unit 207 on the display device 115. Details of a display control method will be described below.

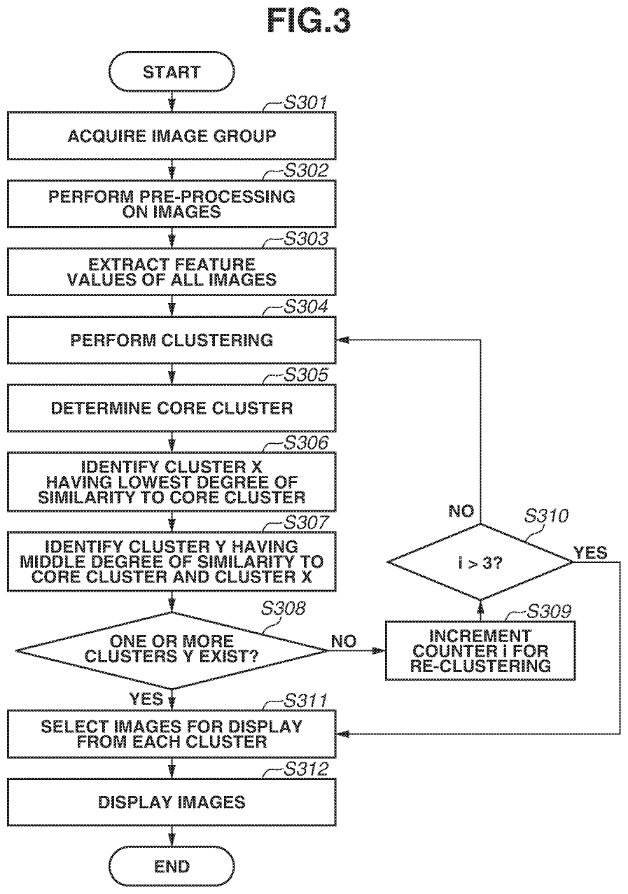

FIG. 3 is a flowchart illustrating a processing procedure of the information processing apparatus 100.

Subsequently, the overall steps of processing performed by the information processing apparatus 100 according to the present exemplary embodiment will now be described. FIG. 3 is a flowchart illustrating the overall steps of the processing performed by the information processing apparatus 100 according to the present exemplary embodiment.

In step S301, the acquisition unit 201 acquires an image group as a processing target. In this step, the acquisition unit 201 may also acquire related information regarding each image together. The related information is, for example, rank information indicating likelihood of being an acquisition target. Specifically, for a face image of the human figure “A” as the acquisition target, the rank information is numbers allocated as 1, 2, and so on in the descending order from the face image with the highest likelihood of being the human figure “A”. The rank information is output from the acquisition source of the image group. For example, if a face image group of a specific human figure is acquired from a system that searches for human figures, degrees of similarity to a face image of the specific human figure serves as the rank information. The degree of similarity is likelihood or the like obtained when matching with the face image of the specific human figure as a search query is performed. If face images are sequentially output in the descending order of degrees of similarity, the output order serves as the rank information. If the output order of face images as a search result from collection of a face image group from web search reflects the likelihood, the output order serves as the rank information. The rank information is not necessarily unique, and images with an identical value may overlap with each other.

In step S302, the extraction unit 202 performs pre-processing on each image acquired in step S301 to obtain a preferable feature in feature extraction. For face images as the processing target, the pre-processing is normalization of each face image. Specifically, the pre-processing is processing of face-detection processing on a face image as the processing target to estimate positions of facial organ points, such as eyes, a nose, and a mouth, geometric transformation to position the face at the center of the image based on the positions of the estimated organ points, and moving the face to the center of the image. Other pre-processing includes removal of noise superimposed on the image and trimming.

In step S303, the extraction unit 202 extracts feature values from the images acquired in step S301. There is a method using a feature extraction model trained using a residual neural network (ResNet), which is a deep neural network, as described in Kaiming He, et. Al, to extract feature values. The feature extraction model is trained to output a more similar feature value from an image that is estimated to have higher likelihood of being an identical human figure using a great number of images as data for training. In this step, for example, data having normalized values in the range of 0 to 1 in several hundred dimensions is obtained as feature values (Kaiming He, et. al., Deep Residual Learning for Image Recognition in 2016 IEEE Conference on Computer Vision and Pattern Recognition (CVPR)).

In step S304, the clustering unit 203 performs clustering of the image group acquired in step S301 using the feature values extracted in step S303. In the present exemplary embodiment, hierarchical clustering is used. A distance function for clustering (such as Euclidean distance or cosine similarity) and a method for measuring a distance between clusters (such as group averaging method or Ward's method) are not limited. In the present exemplary embodiment, the following is a description of a case where cosine similarity (hereinafter referred to as a degree of similarity) is used as a distance function for feature values of face images.

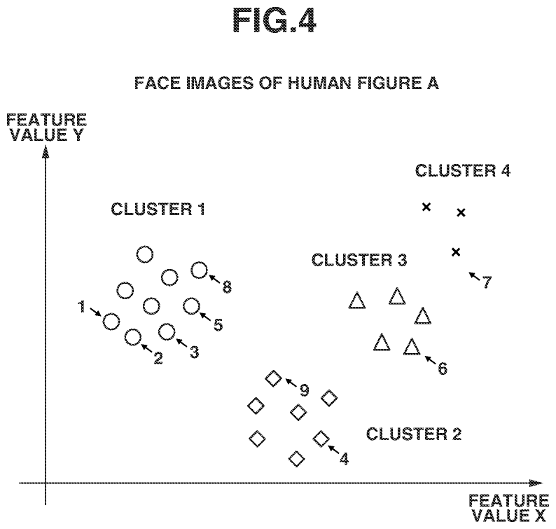

FIG. 4 illustrates an example of a result of clustering performed by the clustering unit 203. FIG. 4 illustrates a case where four clusters 1 to 4 are generated as a result of clustering. In FIG. 4, feature values (elements) extracted from each image are represented by a circle mark, a diamond mark, a triangle mark, and an x-mark on a two-dimensional feature value space formed by a feature value X and a feature value Y as respective axes. The feature value X and the feature value Y are included in feature values extracted in step S303. A circle mark represents an element included in the cluster 1. A diamond mark represents an element included in the cluster 2. A triangle mark represents an element included in the cluster 3. An x-mark represents an element included in the cluster 4. Further, a known dimensional reduction method may be used as a method of representing feature values in the two-dimensional feature value space.

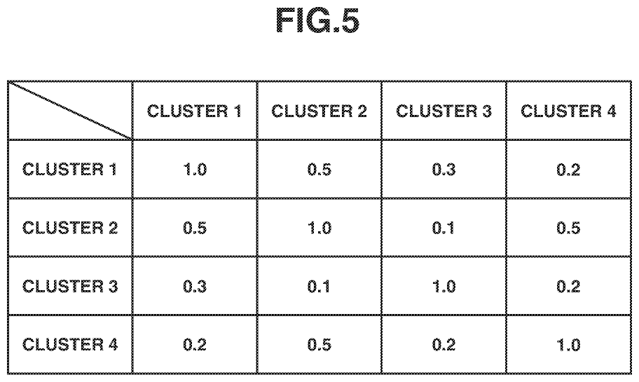

The process of hierarchical clustering typically includes calculating a degree of similarity between clusters, and changing the number of clusters to be generated through comparison with a threshold for determination whether a cluster with a different degree of similarity is regarded as an identical cluster. In the case of the degree of similarity used as the distance function in clustering as described above, a higher threshold makes it easier for clusters to be regarded as different clusters, which will increase the number of clusters to be generated. In contrast, a lower threshold makes it easier for a lot of clusters to be regarded as an identical cluster, which will decrease the number of clusters to be generated. In the present exemplary embodiment, as at least three clusters, i.e., the core cluster, the first core cluster, and the second cluster are to be identified, a threshold with which at least three clusters will be generated is set in advance. FIG. 4 illustrates a result of clustering at a set threshold of 0.7. That means that degrees of similarity between clusters 1 to 4 are smaller than 0.7. The clustering unit 203 stores degrees of similarity between the clusters obtained as a result of clustering in the ROM 112. FIG. 5 illustrates degrees of similarity between the clusters in FIG. 4. FIG. 5 also shows that the degrees of similarity between the clusters 1 to 4 are smaller than 0.7. A number beside an arrow directed at each element in FIG. 4 indicates the rank information acquired by the acquisition unit 201. For simplification, all of elements whose ranks are other than first to ninth are assumed to be ranked at tenth, and the rank information regarding these elements is omitted.

In step S305, the determination unit 204 determines the core cluster. The core cluster is the most representative cluster of the image groups as the processing target acquired in step S301, out of the plurality of clusters generated as a result of processing in step S304. Specifically, the core cluster is a cluster composed of an aggregation of face images with the highest likelihood of being the identical person (an aggregation of face images obviously representing the human figure A). Conditions used when the determination unit 204 determines the core cluster are as follows.
Condition 1: a degree of similarity between elements (feature values) included in a cluster is high
Condition 2: the number of elements included in a cluster is large
Condition 3: a lot of elements having rank information indicating smaller numbers are included

In the present exemplary embodiment, the determination unit 204 calculates a core cluster confidence score of each cluster under the above-described Conditions 1 to 3. The core cluster confidence score takes a value in the range from 0 to 1, for example. A higher value indicates that the human figure is more obviously the human figure A. Specifically, the determination unit 204 calculates a core cluster confidence score CC of each cluster using the following Expressions 1 to 4.

$${CC}_{1} = \frac{{\sum }_{i , j ∈ {s}_{ele}} {sim}_{ij}}{{n ( {s}_{ele} )}^{{P}_{2}}} \qquad Expression 1$$

$${CC}_{2} = \frac{n ( {S}_{ele} )}{n ( {S}_{all} )} \qquad Expression 2$$

$${CC}_{3} = \frac{{\sum }_{i ∈ {s}_{ele \frac{1}{{r}_{i}}}}}{{\sum }_{j ∈ {s}_{{all}^{\frac{1}{rj}}}}} \qquad Expression 3$$

$$CC = {α}_{1} \times {CC}_{1} + {β}_{1} \times {CC}_{2} + {γ}_{1} \times {CC}_{3} \qquad Expression 4$$

Signs in the above-described Expressions 1 to 4 represent the following.
i,j: element numbers indicating respective elements
α₁, β₁, γ₁: constants that satisfy α₁+β₁+γ₁=1
Sₑₗₑ: an aggregation of element numbers included in the cluster
Sₐₗₗ: an aggregation of all element numbers
simᵢⱼ: a degree of similarity between an element i and an element j
n(S): the number of elements in an aggregation S
n(Sₑₗₑ): the number of elements included in the cluster
n(Sₐₗₗ): the number of all elements
ₙPₖ: a total number of permutations obtained by selection of k elements from n elements
rᵢ: a rank number of the element i

A core cluster confidence score CC₁ that takes a higher value as Condition 1 is more satisfied is calculated by using the above-described Expression 1. A core cluster confidence score CC₂ that takes a higher value as Condition 2 is more satisfied is calculated by using the above-described Expression 2. A core cluster confidence score CC₃ that takes a higher value as Condition 3 is more satisfied is calculated by using the above-described Expression 3.

The core cluster confidence scores CC₁ to CC₃ calculated as just described are substituted into the above-described Expression 4, whereby a comprehensive core cluster confidence score CC is calculated. Values of CC₁ to CC₃ based on Conditions 1 to 3 are used as described above, but an evaluation value for a core cluster confidence score calculated based on other conditions may be used. A value of any one of CC₁ to CC₃ may be selectively used. The above-described Expressions 1 to 3 are examples, and a specific expression is not required as long as an evaluation value of a core cluster confidence score based on Conditions 1 to 3 is represented.

Subsequently, a specific procedure for determining the core cluster among the clusters 1 to 4 illustrated in FIG. 4 will be described.

First, the determination unit 204 calculates the core cluster confidence score CC regarding each cluster using the above-described Expressions 1 to 4. Assume that the average value of degrees of similarity between elements is 0.9 in the cluster 1, 0.9 in the cluster 2, and 0.8 in the cluster 3, and 0.8 in the cluster 4. Assume that α1=0.3, β1=0.1, and γ1=0.6. As illustrated in FIG. 4, the number of elements included in the cluster 1 is nine, the number of elements included in the cluster 2 is seven, the number of elements included in the cluster 3 is five, and the number of elements included in the cluster 4 is three. The number of all the elements is 24.

An example of calculating the core cluster confidence score CC regarding the cluster 1 will now be described.

The core cluster confidence score CC₁ is a value obtained by dividing a sum of degrees of similarity between elements by all combinations, and thus is equal to the average value of degrees of similarity between the elements in a cluster. In the cluster 1, CC₁=0.9. The core cluster confidence score CC₂ is the number of elements in a cluster with respect to the total number of elements. The larger the number of elements in a cluster is, the higher the core cluster confidence score CC₂ becomes. In the cluster 1, CC₂=9/(9+7+5+3)=0.375. The core cluster confidence score CC₃ is a confidence score calculated based on rank information. As a cluster includes more elements with smaller rank values, the core cluster confidence score CC₃ becomes higher. In the cluster 1, (1/1+1/2+1/3+1/5+1/8+1/10×4)/(1/1+1/2+1/3+1/4+1/5+1/6+1/7+1/8+1/9+1/10×(24−9))=0.59. Finally, using CC₁ to CC₃ calculated as described above, the core cluster confidence score CC is obtained as CC=0.3×0.9+0.1×0.375+0.6×0.59=0.662.

Respective core cluster confidence scores of the clusters 2 to 4 are similarly calculated. Assuming that CC=0.419 is obtained in the cluster 2, CC=0.339 is obtained in the cluster 3, and CC=0.30 is obtained in the cluster 4 as the results of the calculation, it is the cluster 1 that has the highest core cluster confidence score. Consequently, the cluster 1 is determined to be the core cluster.

In step S306, the first identification unit 205 identifies a cluster with the lowest degree of similarity to the core cluster determined in step S305 as the first cluster. The first cluster may be hereinafter referred to as a cluster X. The degrees of similarity between the clusters have been already calculated in the clustering in step S304. The first identification unit 205 refers to the degrees of similarity between the clusters stored in the ROM 112 to identify the cluster with the lowest degree of similarity to the core cluster. In the example in FIG. 5, as it is the cluster 4 that has the lowest degree of similarity to the cluster 1 as the core cluster, the cluster X is identified as the cluster 4. The cluster X is a cluster composed of an image group that is the least similar to the core cluster. The cluster to be identified here is a cluster composed of a face image group with the lowest likelihood of being the human figure “A”.

In step S307, the second identification unit 206 identifies a cluster with a degree of similarity to the core cluster identified in step S305 within a middle range and with a degree of similarity to the cluster X identified in step S306 within a middle range, as the second cluster. The second cluster may be hereinafter referred to as a cluster Y. The middle range is a predetermined range from 0 to 1.0, for example, a range from 0.45 to 0.55, where the degree of similarity is defined in a range from a minimum value of 0 to a maximum value of 1.0. In other words, the second identification unit 206 identifies the cluster composed of a group image with middle degrees of similarity to the core cluster and the cluster X. In the case illustrated in FIG. 5, as the degree of similarity of the cluster 2 to the cluster 1 is 0.5 and the degree of similarity of the cluster 2 to the cluster 4 is also 0.5, the cluster 2 is identified as a cluster with a middle degree of similarity to both the core cluster and the cluster X. The cluster Y has middle degrees of similarity to a cluster composed of a face image group with the highest likelihood of being “A” (core cluster) and a cluster composed of a face image group with the lowest likelihood of being the human figure “A” (cluster X). The cluster to be identified here is a cluster composed of a face image group with middle likelihood of being the human figure “A”. One or more clusters may correspond to the cluster Y. If there is no cluster with a degree of similarity between 0.45 and 0.55, a cluster with a degree of similarity that is the closest to 0.45 to 0.55 may be identified.

In step S308, the clustering unit 203 determines whether the cluster Y has been identified in step S307. If the clustering unit 203 determines that the cluster Y has been identified (YES in step S308), the processing proceeds to step S311. If the clustering unit 203 determines that the cluster Y has not been identified (NO in step S308), the processing proceeds to step S309. In step S309, the clustering unit 203 increments a clustering counter i indicating the number of times clustering is performed, and the processing returns to step S304. In step S304, the clustering unit 203 performs re-clustering. In the re-clustering, in order to generate clusters as candidates for the cluster Y, the clustering unit 203 sets a threshold that is greater than that at the time of the previous clustering to increase the number of clusters. After that, the information processing apparatus 100 performs the processing from steps S305 to S307 again, and identifies a cluster corresponding to the cluster Y. However, because there is a possibility that no cluster corresponding to the cluster Y exists even if the re-clustering is performed, clustering is performed with an upper limit set to a predetermined number (for example, three) as the number of times clustering is performed. The clustering unit 203 increments the clustering counter i every time the processing enters the step of the re-clustering (in step S309). In step S310, the clustering unit 203 thereby determines whether the clustering counter i exceeds the predetermined number. If the clustering unit 203 determines that the clustering counter i exceeds the predetermined number (YES in step S310) after repeating the re-clustering until the clustering counter i exceeds the predetermined number, the processing proceeds to step S311.

In step S311, the selection unit 207 selects images for display from the clusters. The clusters herein are the core cluster, the cluster X, and the cluster Y identified by the processing so far. The selection unit 207 selects an identical number of images from an image group belonging to each cluster to prevent a lot of images of a specific cluster from being displayed. For example, as images for display, the selection unit 207 selects three face images from the cluster 1 as the core cluster, three face images from the cluster 4 as the cluster X, and three face images from the cluster 2 as the cluster Y. The selection unit 207 selects images corresponding to elements closer to the center of each cluster so that a representative image of each cluster will be displayed.

In step S312, the display control unit 208 performs control to display the images for display selected in step S311 on the display device 115. After that, the processing in this flowchart ends.

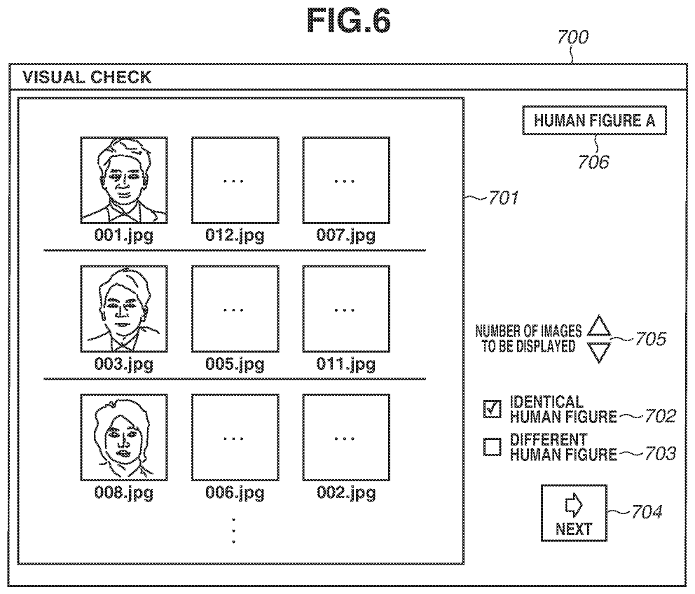

FIG. 6 illustrates a display screen example on which the face images selected as the images for display are displayed. A display screen 700 in FIG. 6 is displayed on the display device 115. On the display screen 700 illustrated in FIG. 6, a window 701 on which the face images selected as the images for display are arranged, a name 706 of the human figure that is a target of collection in step S301, and various kinds of user interfaces (UIs), from which determination as to whether each face image displayed on the window 701 is the identical human figure is input, are displayed. The face images displayed on the window 701 are face images normalized by pre-processing on the images in step S302. The user visually checks the face images on the window 701, and determines whether all the face images are of the identical human figure. On the display screen 700, check boxes 702 and 703 for input of the determination made by the user and a NEXT button 704 are displayed. If the user determines that all the displayed face images are of the identical human figure, the user checks the check box 702. If the user determines that a face image of a different human figure is included, the user checks the check box 703. Each of the check boxes 702 and 703 is a UI example for causing the user to make selection about whether displayed data is of an identical type.

If the NEXT button 704 is pressed, processing for transition to determination about the face image of the different human figure is started.

The above-described UI is merely an example, and the user's operation can be input by another means. For example, in consideration of work efficiency of the user, a configuration may be used that allows the determination about whether the face images are of the identical human figure to be input through keyboard operations alone.

As illustrated in FIG. 6, the face images selected as the images for display are collectively displayed on the window 701 for each cluster to which the face images belong. Furthermore, clusters to which the face images belong are displayed in the order of the core cluster, the cluster Y, and the cluster X. In FIG. 6, three face images selected from the core cluster are displayed in the top part on the window 701, three face images selected from the cluster Y are displayed in the middle part on the window 701, and three face images selected from the cluster X are displayed in the bottom part on the window 701. This shows the user face images in the order of a face image group with the highest likelihood of being a specific human figure, a face image group with middle likelihood of being the specific human figure, and a face image group with the lowest likelihood of being the specific human figure. In the present exemplary embodiment, face images constituting the cluster with the middle likelihood of being the specific human figure among all the clusters, i.e., middle likelihood faces are displayed. Contrasting the face image group with the highest likelihood of being the specific human figure and the face image group with the lowest likelihood of being the specific human figure can prevent erroneous determination that the human figure represented by these face image groups is a different human figure. A form of displaying the face images illustrated in FIG. 6 is merely an example, and a form of displaying the face images framed for each cluster to which the images belong may be employed. This facilitates the user's determination about which face image is similar to the specific human figure.

An up/down button 705 is also displayed on the display screen 700. When the user presses an up (triangle) button or down (inverted triangle) button of the up-and-down button 705, the display control unit 208 increases or decreases the number of images to be displayed on the window 701. Specifically, when the user presses the up (triangle) button, the selection unit 207 increases the number of images to be selected for display from each cluster, and the display control unit 208 newly displays the additionally selected image(s) on the window 701. For example, assuming that three images for display are selected from each cluster, when the user presses the up (triangle) button, the number of images for display to be selected from each cluster is changed to four. While the cluster 4 is identified as the cluster X in the present exemplary embodiment, three elements are included in the cluster 4, and thus it is assumed that the number of images for display to be selected from the cluster X remains to be three. Consequently, the number of images to be displayed on the window 701 is increased from nine to eleven.

According to the present exemplary embodiment as just described, when the image group belonging to each cluster generated as a result of clustering is displayed, the image group having the middle degree of similarity to each of these image groups is displayed together with the image group with the highest likelihood of being the target human figure and the image group with the lowest likelihood of being the target human figure. In comparison between the image group with the highest likelihood of being the target human figure and the image group with the lowest likelihood of being the target human figure, displaying the image group with the middle degree of similarity facilitates determination about whether these image groups are of the identical human figure, providing a higher work efficiency in operation of checking results of clustering.

As a modification of the present exemplary embodiment, when the cluster Y is not identified in step S308 (NO in step S308) in the flowchart in FIG. 3, the first identification unit 205 may re-identify the cluster X instead of re-clustering performed by the clustering unit 203. This is because, if a cluster like obviously noise is identified as the cluster X, the cluster Y with the middle degree of similarity becomes less likely to be identified. To re-identify the cluster X, the first identification unit 205 re-identifies, as the cluster X, a cluster with the lowest degree of similarity among clusters excluding a predetermined number or predetermined ratio of clusters with lower degrees of similarity to the core cluster. Clusters that each have a degree of similarity at a predetermined threshold or less may be excluded. This shortens the distance between the core cluster and the cluster X on the feature value space, and makes it easier for a cluster corresponding to the cluster Y to be identified.

A second exemplary embodiment will now be described. In the first exemplary embodiment, the description has been given of the display method used when a user is caused to determine whether the whole of the face images to be displayed are of a target human figure. In the second exemplary embodiment, a display method will be described that is used when a user is caused to determine whether each cluster or each image is of a target human figure. In the following description, the redundant description common to the first exemplary embodiment will be omitted, and differences from the first exemplary embodiment will be mainly described.

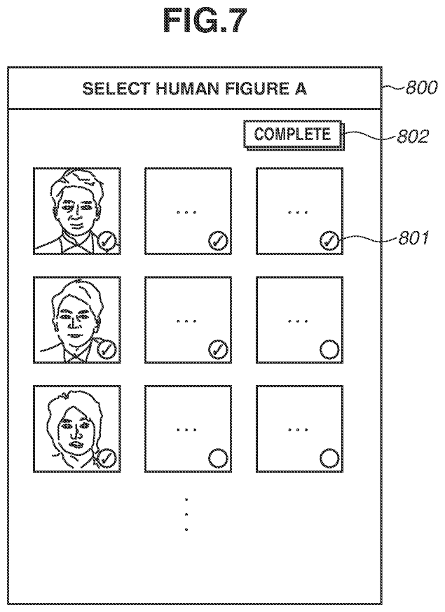

FIG. 7 illustrates an example of a display screen for causing a user to determine whether each image is of the human figure “A”. Images estimated to be of the human figure “A” among images captured by, for example, a mobile terminal represented by a smartphone are displayed as a result of the processing in the flowchart in FIG. 3 on a display screen 800 illustrated in FIG. 7. The display screen 800 in FIG. 7 is displayed on the display device 115. On the display screen 800, face images selected from the core cluster, the cluster Y, and the cluster X sequentially arranged from the top are displayed side by side similarly to the window 701 in FIG. 6. A check box 801 is displayed in association with each displayed face image. The user is caused to select images that look to be of the human figure “A”. The check box may be displayed for each cluster so that the user is caused to select a cluster composed of images of the human figure “A”. The check box 801 is an example of a UI for causing the user to make selection about whether each displayed data is a target type of data. Selected images are registered as images of the human figure “A”, and non-selected images are registered as images of human figures other than the human figure “A”. While details of a registration method after the selection are not described in the present exemplary embodiment, the information processing apparatus 100 may register the other images that are not selected as the images of the human figure “A” based on the selected images and distribution in corresponding clusters to which the images belong. When a COMPLETE button 802 is pressed, the display screen 800 is closed.

As described above, the present exemplary embodiment allows the user to determine whether each cluster of the displayed face images or each of the displayed face images is of the target human figure. Also in this case, similarly to the first exemplary embodiment, the image group with the middle degree of similarity to each of these image groups is displayed, together with the image group with the highest likelihood of being the target human figure and the image group with the lowest likelihood of being the target human figure. This provides a higher work efficiency in operation of checking whether each image is of the target human figure.

### Other Exemplary Embodiments

The present disclosure includes a case where a program of software is installed directly or remotely in a system or an apparatus, and functions of the exemplary embodiments described above are implemented by the system or a computer of the apparatus reading out and running codes of the installed program. In this case, the installed program is a computer-readable program for the flowchart illustrated in the exemplary embodiments. Further, the functions of the above-described exemplary embodiments may be implemented by the computer running the readout program, or may be implemented by the computer in collaboration with an operating system (OS) on the computer based on instructions of the program. In this case, the OS or the like performs part or all of actual processing, and the functions of the above-described exemplary embodiments are implemented by the processing.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-087373, filed May 30, 2022, which is hereby incorporated by reference herein in its entirety.

What is claimed is:

1. An information processing apparatus comprising:
a processor; and
a memory storing one or more programs configured to be executed by the processor, the one or more programs including instructions for:
performing clustering on a data group based on a feature value of each of a plurality of pieces of data;
determining a representative cluster among clusters generated;
identifying a first cluster based on a degree of similarity between each of the clusters generated and the representative cluster;
identifying a second cluster based on a first degree of similarity, which is the degree of similarity between each of the clusters generated and the representative cluster, and a second degree of similarity, which is a degree of similarity between each of the clusters generated and the first cluster; and
selecting at least one piece of data for display from among the representative cluster, the first cluster, and the second cluster.

2. The information processing apparatus according to claim 1, wherein the second cluster is identified as, a cluster whose first degree of similarity is a value in a predetermined range between a minimum degree of similarity and a maximum degree of similarity and whose second degree of similarity is a value in the predetermined range between the minimum degree of similarity and the maximum degree of similarity.

3. The information processing apparatus according to claim 2, wherein the predetermined range is a middle range.

4. The information processing apparatus according to claim 1, wherein the first cluster is identified as, a cluster having a lowest degree of similarity to the representative cluster.

5. The information processing apparatus according to claim 4, wherein the first cluster among clusters excluding a predetermined number or predetermined ratio of clusters having lower degrees of similarity to the representative cluster is identified.

6. The information processing apparatus according to claim 1, further comprising performing control to display the at least one piece of data for display such that the at least one piece of data is arranged for each of the clusters to which the at least one piece of data for display belongs.

7. The information processing apparatus according to claim 6, further comprising performing control to display the at least one piece of data for display in order of the representative cluster, the second cluster, and the first cluster.

8. The information processing apparatus according to claim 6, further comprising displaying a user interface (UI) to cause a user to input whether the at least one piece of data for display is an identical type of data.

9. The information processing apparatus according to claim 6, further comprising displaying a UI to cause a user to input whether each of the at least one piece of data for display is a target type of data.

10. The information processing apparatus according to claim 1, wherein the representative cluster is determined as, a cluster having a higher degree of similarity between feature values of a plurality of pieces of data included in the cluster having the higher degree of similarity.

11. The information processing apparatus according to claim 1, wherein the representative cluster is determined as, a cluster including a larger number of pieces of data.

12. The information processing apparatus according to claim 1, further comprising acquiring a target data group,
wherein each acquired piece of the plurality of pieces of data is associated with rank information indicating a rank regarding likelihood of being a target, and
wherein the representative cluster is determined as, a cluster including a larger number of data having the rank information indicating smaller numbers.

13. The information processing apparatus according to claim 1, wherein, with the second cluster not identified, re-clustering on the data group is performed.

14. The information processing apparatus according to claim 1, wherein, with the second cluster not identified, the first cluster among clusters excluding a predetermined number or predetermined ratio of clusters having lower degrees of similarity to the representative cluster is re-identified.

15. The information processing apparatus according to claim 1, wherein a degree of similarity between the clusters obtained as a result of the clustering performed is used.

16. The information processing apparatus according to claim 1, wherein the data group as a processing target is an image group.

17. An information processing method comprising:
performing clustering on a data group based on a feature value of each of a plurality of pieces of data;
determining a representative cluster among clusters generated by the clustering;
performing first identification to identify a first cluster based on a degree of similarity between each of the clusters generated by the clustering and the representative cluster;
performing second identification to identify a second cluster based on a first degree of similarity, which is the degree of similarity between each of the clusters generated by the clustering and the representative cluster, and a second degree of similarity, which is a degree of similarity between each of the clusters generated by the clustering and the first cluster; and
selecting at least one piece of data for display from among the representative cluster, the first cluster, and the second cluster.

18. A non-transitory recording medium that records a program that causes a computer to execute an information processing method, the method comprising:
performing clustering on a data group based on a feature value of each of a plurality of pieces of data;
determining a representative cluster among clusters generated;
identifying a first cluster based on a degree of similarity between each of the clusters generated and the representative cluster;
identifying a second cluster based on a first degree of similarity, which is the degree of similarity between each of the clusters generated and the representative cluster, and a second degree of similarity, which is a degree of similarity between each of the clusters generated and the first cluster; and
selecting at least one piece of data for display from among the representative cluster, the first cluster, and the second cluster.
